(19) United States
(12) Patent Application Publication
(10) Pub. No.: US 2025/0384331 A1
(43) Pub. Date: Dec. 18, 2025

(54) SCHEDULE BARRIERS FOR A GENETIC ALGORITHM

(71) Applicant: nMetric, LLC, Dallas, TX (US)

(72) Inventors: Christine Koski, Dallas, TX (US); Stephen Cook, Albuquerque, NM (US)

(21) Appl. No.: 18/742,747

(22) Filed: Jun. 13, 2024

(51) Int. Cl. G06N 20/00

(52) U.S. Cl. CPC G06N 20/00

(57) ABSTRACT

A system for enforcing schedule barriers within a genetic algorithm includes one or more computing devices programmed to determine whether a job or a task within a job includes a hold that would prevent the execution of any tasks or jobs before that date/time, apply the hold as a virtual nowline within a generated genome and prevent the genetic algorithm from scheduling tasks before the virtual nowline. Having determined and enforced the virtual nowline, the system can proceed to execute tasks that start after the virtual nowline.

### FIELD OF THE INVENTION

The field of the invention is computer-based scheduling systems.

### BACKGROUND

The background description includes information that may be useful in understanding the present invention. It is not an admission that any of the information provided herein is prior art or relevant to the presently claimed invention, or that any publication specifically or implicitly referenced is prior art.

In the execution of jobs, sometimes certain tasks or other jobs cannot be completed unless certain conditions are satisfied. Often times, these conditions can be related to the meeting of a certain condition (for example, a material hold, a financial term, etc.) at a particular time.

Unfortunately, current scheduling systems can only take into account the present (the actual nowline) without considering the restrictions associated with specific tasks or factors affecting those tasks.

Thus, there is still a need for an improved scheduling system that can account for these restrictions effectively and without wasting computing resources.

### SUMMARY OF THE INVENTION

The inventive subject matter provides apparatus, systems and methods in which a scheduling computing system can enforce schedule barriers within a genetic algorithm. The computing system can determine whether, for a job to be executed, any tasks within the job or whether any other job contains any holds that would affect the current job.

The hold can, for example, be a material hold, a technical hold, a payment hold, or any other type of hold.

In embodiments of the inventive subject matter, the hold can be expressed within a task as a condition having a flag.

If the computing device determines that a hold exists, the computing device applies a date and time of the hold as a virtual nowline within the genetic algorithm.

The computing device then prevents the genetic algorithm from scheduling any tasks that begin or occur before the established virtual nowline.

In preferred embodiments of the inventive subject matter, the virtual nowline is different from the actual nowline (which is the present time).

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIGS. 1A and 1B are an illustrative example of an assembly of a genome, according to embodiments of the inventive subject matter.

FIG. 2 is a flowchart of the processes executed by a computing device, according to an embodiment of the inventive subject matter.

FIG. 3 shows the jobs of FIG. 1A, with a virtual nowline corresponding to a hold of task within a job, according to embodiments of the inventive subject matter.

FIG. 4 illustrates an embodiment of the inventive subject matter where the genome was created despite the virtual nowline.

FIG. 5 illustrates an embodiment of the inventive subject matter where the computing device determines and implements the virtual nowline before assembling the genome.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

A computer-based scheduling system can account for one or more types of scheduling problems that can be based on factors such as the type of organization, the type of jobs and/or tasks involved, available times, etc. Some examples of the types of scheduling problems these systems are expected to handle include:

Open shop scheduling. In open shop scheduling, each job has a task on each available machine, without any types of ordering constraints. Thus, the tasks can be performed in any order. Typically, there's no parallel work on a job.

Flow shop scheduling: In flow shop scheduling, each job has a task on each machine. Unlike open shop scheduling, the order of the tasks matters in flow shop scheduling.

Permutation flow shop: Permutation flow ship is similar to flow shop scheduling, but the machine must perform the jobs (and the tasks therein) in the same order.

Job shop (“JSP”) scheduling, also known as Job-Shop Scheduling Problem (“JSSP”): the goal for JSP is to minimize “makespan”. This means that the goal for JSP is to compress the schedule as much as possible.

Flexible job shop (“FJSP”) scheduling: This is similar to the job shop scheduling, but the resources are interchangeable.

Truthful job scheduling: The resources available can perform any task in the job, but they take different time. For example, the resources can include personnel that have different skill levels at performing the task.

One challenge that computer-implemented scheduling systems face is that schedule generation for many jobs having many tasks is an “NP-hard” problem. For example, an open shop scheduling problem with “n” jobs and “m” resources has (n!)^{m} possible combinations. For 10 jobs with 10 resources, that means 3.95*10⁶⁵ possible schedules.

While scheduling types with more restrictions have a lower potential amount of schedules, the combinations are still staggering and simply too many for a computer system to brute force a “best” schedule.

Current systems use simple heuristic deterministic scheduling algorithms:

R (Random)—Pick any Job in Queue with equal probability. This rule is often used as benchmark for other rules

FCFS (First Come First Serve)—Jobs are processed in the order in which they arrived at the work center (also called earliest release date)

SPT (Shortest Processing Time)—This rule tends to reduce both work-in-process inventory, the average job completion (flow) time, and average job lateness. SPT can also be used to break ties.

EDD (Earliest Due Date)—Choose Job that has earliest due date

CR (Critical Ratio)=Processing Time/Time until due (Due Date−Current Time). Take the highest value.

LWR (Least Work Remaining)—This rule is an extension of SPT variant that considers the number of successive operations

ST (Slack Time)=Time until job is due−(Sum of processing time remaining). Take the job with the smallest amount of slack time.

ST/O (Slack Time per Remaining Operation)=slack time divided by number of operations remaining. Take the job with the smallest amount of slack time per remaining Operation.

Existing systems have also employed more “complex” scheduling heuristics, such as Johnson's Algorithm (that uses Bellman-Ford), Kusiak's Algorithm, Palmer's Algorithm, Gupta's Algorithm, Shifting Bottleneck Algorithm, Campbell-Dudek-Smith (“CDS”) Algorithm, and/or Nawas-Enscore-Ham (“NEH”) Algorithm.

However, for the most part these all simply employ variations and/or combinations of the simple heuristics. While these approaches may get acceptable results in a human-scale amount of time, none are guaranteed to find optimal solutions.

Existing scheduling systems employ fitness functions that use common variables such as processing time, release date, due date, weight, lateness, makespan, and release date. Common fitness functions will then return “raw” fitness scores that can be combined with user-supplied specific factors to weight the fitness scores. For example, an output of the fitness function can be a measure of robustness, which reflects the sensitivity of the schedule to problems/interruptions in a flow. Typically, to improve robustness, a system can add idle times, schedule less flexible jobs first, and forward-schedule as many tasks as possible. In another example, the output of the fitness function can be a measure of tightness, which minimizes the absolute size of the lateness.

As discussed herein a job is made up of tasks. Tasks are discrete functions or processes that are the subparts of a job. The tasks of a job are often sequential such that one or more tasks may need to be completed for a subsequent one or more tasks of a job to start.

A task requires one or more resources to complete. A resource can be anything that a task may need to be completed. Examples of resources can include equipment, personnel, locations, etc.

A genome as discussed herein can be considered to be a list of tasks. In the examples discussed herein, a genome can include all of the tasks from all of the jobs associated with an organization or a process within an organization.

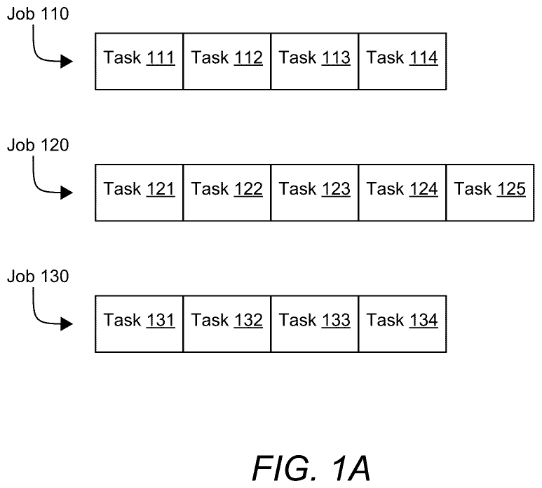

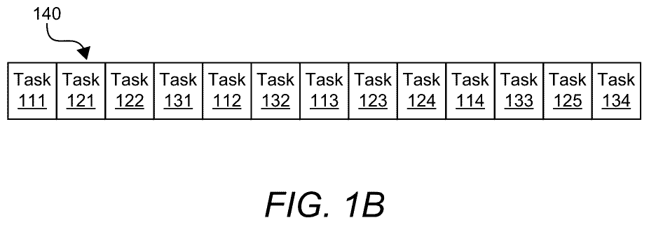

An example of the assembly of a genome is seen in FIGS. 1A and 1B.

FIG. 1A illustrates a plurality of jobs 110, 120, 130 with their respective tasks organized sequentially according to the job. Thus, job 110 will have task 1 (block 111), task 2 (block 112), task 3 (block 113) and task 4 (block 114) that need to be performed for the job 110 to be completed. Likewise, job 120 has tasks 1-5 (blocks 121-125, respectively) and job 130 has tasks 1-4 (blocks 131-134, respectively).

To create a genome, the computing device gets all of the tasks associated with all of the jobs and mixes them up to create a list from all of these tasks. FIG. 1B shows an example of a genome created from all of the tasks of jobs 110, 120 and 130. Generally speaking the tasks can be mixed up in almost any order, though the assembly of a genome can be subject to rules. For example, one rule of a genome is that the tasks must be for any job along the length of the genome. This means that while the tasks of a genome are not required to be consecutive or next to one another, a task for a job cannot precede an earlier task from the same job. Thus, in this example, task 3 (block 113) of job 110 cannot be before task 2 (block 112) of the same job 110 within an assembled genome.

The jobs 110, 120, 130 and their respective tasks are relatively small in number for the purposes of illustration. It is contemplated that, in preferred embodiments, the system will handle over 10 jobs with over 10 tasks each. In still other preferred embodiments, the system will be tasked to handle over 100 jobs with many tasks (over 10, over 100, over 1000). Systems handling orders of magnitude more jobs and tasks will see increased benefits of the systems and methods of the inventive subject matter.

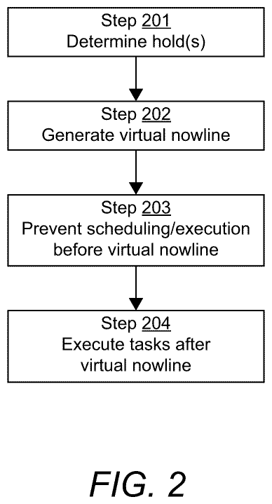

FIG. 2 is a flowchart of the processes executed by a computing device, according to an embodiment of the inventive subject matter.

At step 201, the computing system determines, for a job to be executed within a genome, whether the job contains any holds for one or more tasks within the job.

A hold can be considered to represent a condition at a particular date (or time from the present) that prevents or stops a task from processing or being completed.

Examples of hold can include a material hold (e.g., the availability of a raw material necessary for a task is not available before a particular date/time), a technical hold (e.g., a particular piece of equipment is required to be available by a particular date/time) or a payment term (e.g., a task can be in the queue of the genome but the task and/or genome execution cannot begin until payment is received).

In embodiments of the inventive subject matter, the hold comprises a condition having a flag. The flag can be an extra bit within the data structure of a task that the computing device can detect and act upon. The flag can also include associated data that includes a date/time indicator that denotes the date/time of the hold. Thus, in these embodiments the computing device at step 201 determines whether the data structure of the task includes a flag representing a hold.

Upon determining that the job contains a hold, at step 202, the computing system generates a virtual nowline corresponding to a date and time of the hold.

The virtual nowline can be considered to be a future time before which nothing can be scheduled. It is a line in the future that the computing device uses to prevent the genetic algorithm from scheduling anything before that future time.

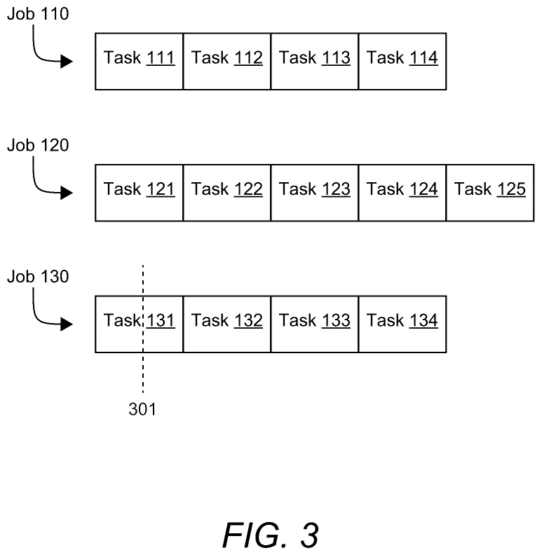

FIG. 3 shows the jobs of FIG. 1A, with the virtual nowline 301 corresponding to a hold of task 131 of job 130.

In preferred embodiments of the inventive subject matter, the virtual nowline is different from the actual nowline. The actual nowline is considered to be the present time or present instant.

At step 203, the computing system then prevents the genetic algorithm from scheduling or executing any tasks that begin or occur before the virtual nowline.

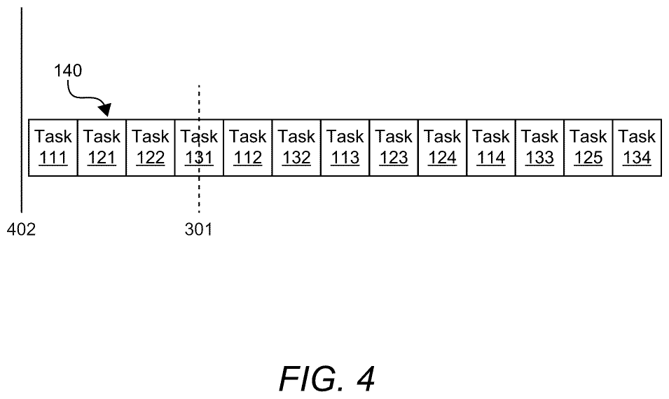

FIG. 4 illustrates an embodiment of the inventive subject matter where the genome 140 was created despite the virtual nowline 301. In these embodiments, the tasks prior to task 131 (tasks 111, 121 and 122) would not be executed. Depending on the necessity of those tasks within their respective jobs, this might also cause some of the tasks of job 110 or 120 after the nowline 301 to not be executed as well.

FIG. 4 also illustrates the actual nowline 401. The actual nowline 401 represents the present date/time. In the example of FIG. 4, the actual nowline 401 is sometime before the start of the execution of the tasks within the genome 140.

The astute reader will appreciate that in this embodiment, the execution of the genome 140 can be started before the task 131 if the hold of the nowline 131 is resolved prior to the start of the execution of the genome 140.

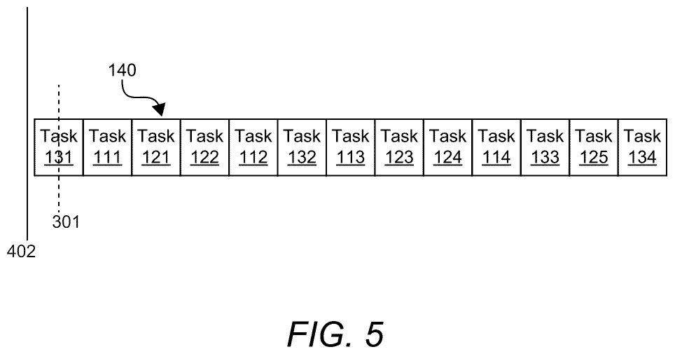

FIG. 5 illustrates an embodiment of the inventive subject matter where the computing device determines and implements the virtual nowline 301 before assembling the genome 140. In this embodiment, the genome 140 is constructed based in part of the virtual nowline 301 such that the task 131 is moved to the front of the genome 140 and/or no tasks are scheduled prior to the task 131.

At step 204, the computing system selects for execution one or more tasks that are scheduled to start after the virtual nowline. In the embodiment of FIG. 5, the computing device simply executes the genome 140 starting with task 131.

In embodiments of the inventive subject matter, the computing device will start with the task following the task with the virtual nowline. This is because, in some situations, the hold makes it impossible to complete or even start the task with the virtual nowline.

In the embodiment of FIG. 4, the computing device starts by executing the task 131. As the task 131 is being executed, the computing device can continue to check whether the hold condition has been satisfied. If, at some point before the task 131 is completed the hold is resolved, the computing device can determine whether any of the other tasks within the genome have a greater ranking or urgency (which can be determined by priority data within each task). If any of the other tasks have a ranking or urgency meeting a particular threshold, the computing device pauses the execution of task 131 and moves to those other tasks.

It is possible that multiple tasks within the jobs used to create a genome have holds and thus have virtual nowlines. In these situations, the computing device is programmed to take select the job with the task having the virtual nowline that is closest to the actual nowline for the genome. Other jobs with tasks having later virtual nowlines are either delayed or removed from the genome altogether.

The systems and methods of the inventive subject matter are discussed herein as being executed by a computing device or computing system. The computing device is contemplated to have one or more processors, one or more non-transitory computer-readable storage medium to store executable code/instructions as well as data used in the processes discussed herein. The systems can include databases integral to or remotely from the computing devices that can store jobs (and the tasks therein). The computing devices have networking capabilities to exchange data with other computing devices, and have input/output interfaces that allow for human operators to enter and receive data/information. While “computing device” in the singular is used herein for simplicity, it is understood that the computing device can be a single computer having the components discussed herein or a plurality of communicatively connected computing devices that collectively carry out the functions and processes discussed herein.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for enforcing schedule barriers within a genetic algorithm, comprising a processor programmed to:
determine, for a job to be executed, whether the job contains any holds for one or more tasks within the job;
based on determining that the job includes a hold, apply the date and time of the hold as a virtual nowline within the genetic algorithm;
preventing, by the processor, the genetic algorithm from scheduling any tasks that begin or occur before the virtual nowline; and
selecting for execution, via the genetic algorithm, at least one task that starts after the virtual nowline.

2. The system of claim 1, wherein the hold comprises at least one of a material hold, a technical hold, a payment hold.

3. The system of claim 1, wherein the hold comprises a condition having a flag.

4. The system of claim 1, wherein the virtual nowline is different from an actual nowline.
